(19) United States
(12) Patent Application Publication
(10) Pub. No.: US 2024/0350353 A1
(43) Pub. Date: Oct. 24, 2024

(54) SEGMENTED GUIDE RAIL AND FRAME OF MASSAGE CHAIR AND MASSAGE CHAIR

(71) Applicant: Shanghai Rongtai Health Technology Corporation Limited, Shanghai (CN)

(72) Inventors: Yang LIU, Shanghai (CN); Junliang WANG, Shanghai (CN); Chuan JU, Shanghai (CN)

(21) Appl. No.: 18/499,404

(22) Filed: Nov. 1, 2023

(30) Foreign Application Priority Data
Apr. 18, 2023 (CN) 2023104177885

(51) Int. Cl. A61H 23/02

(52) U.S. Cl. CPC A61H 23/02; A61H 2201/0149; A61H 2205/081

(57) ABSTRACT

A segmented guide rail of a massage chair contains: a seat track and a support track. The seat track includes a first coupling segment formed on an end thereof, and the support track includes a second coupling segment formed on an end thereof. The first segment and the second segment are connected by two hinge elements, and the seat track and the support track are connected to form at least one connection track on which a massaging mechanism of the massage chair is driven to move back and forth. Thereby, the massaging mechanism of the massage chair moves back and forth, when the support frame rotates to different angles, thus massaging the user in different postures successively.

### TECHNICAL FIELD

The present invention relates to massage equipment, and more particularly to a segmented guide rail and a frame of a massage chair and the massage chair.

### BACKGROUND

A conventional massage chair contains a support frame and a seat frame, and at least one massaging mechanism is arranged on the support frame and the seat frame, wherein a massaging mechanism disposed on the support frame is configured to massage the user's back, and the other massaging mechanism mounted on the seat frame is configured to massage the user's leg.

To avoid the two massaging mechanism interfere with each other, a distance is defined between the seat track and the support track. However, such a distance will occur a disconnection of the support track and the seat track, so the two massaging mechanisms cannot move back and forth on the support track and the seat track, and the user cannot be massaged successively when sitting or lying on the massage chair.

The present invention has arisen to mitigate and/or obviate the afore-described disadvantages.

### SUMMARY

The primary aspect of the present invention is to provide a segmented guide rail, a frame, and a massage chair which contains the support track and the seat track connected with the support track to form the at least one connection track, such that the massaging mechanism moves back and forth on the support track and the seat track, thus massaging the user successively.

To obtain above-mentioned aspect, a segmented guide rail of a massage chair provided by the present invention contains: a seat track and a support track.

The seat track includes a first coupling segment formed on an end thereof, and the support track includes a second coupling segment formed on an end thereof. The first segment and the second segment are connected by two hinge elements. The seat track and the support track are connected to form the at least one connection track on which a massaging mechanism of the massage chair is driven to move back and forth.

Preferably, a respective one hinge element includes a first connection element connected with the seat track and located on the first segment, and the respective one hinge element includes a second connection element connected with the support track and located on the second segment; the first connection element has a first coupling orifice, and the second connection element has a second coupling orifice, wherein a connection shaft is inserted through the first coupling orifice and the second coupling orifice.

Preferably, a defining element is defined between the first segment and the second segment. The defining element has a fixing stop part fixed on the first segment, and the defining element has a rotating limitation part mounted on the second segment. The rotating limitation part contacts with the fixing stop part to stop a rotation of the support track.

Preferably, the support track includes a linear slideway and an arcuate slideway, an end of the arcuate slideway is connected with the linear slideway, and the other end of the arcuate slideway is connected with the second segment.

Preferably, the seat track includes a first slideway and a first rack received in the first slideway. The support track includes a second slideway and a second rack received in the second slideway. When the first rack and the second rack are connected to form the at least one connection track, a graduation line of the first rack is connected with a graduation line of the second rack, and a rotatably axial center of the respective one hinge element is located on a connection of the graduation lines of the first rack and the second rack.

Preferably, the first segment and the second segment have an arcuate face formed on toothed tops thereof, and a center of the arcuate face of the first segment and the second segment is located on the graduation line of the first rack and the graduation line of the second rack.

Preferably, a connection of the seat track and the support track has at least two connection tracks.

Preferably, a frame of the massage chair contains a seat frame, a support frame, and the segmented guide rail, and the seat track is fixed on the seat frame, and the support track is mounted on the support frame.

Preferably, the seat frame has a support structure arranged on a bottom thereof, the support frame has a joining stem disposed on a bottom thereof, and the support structure has a stretching element mounted thereon. The stretching element is connected with the joining stem by way of a tab, and the stretching element pushes the support frame to lift or descend by using the joining stem.

Preferably, a massage chair contains: the frame and the massaging mechanism. The massaging mechanism is disposed on the segmented guide rail, and the massaging mechanism moves back and forth on the at least one connection track.

The segmented guide rail of the massage chair of the present invention contains: a seat track and a support track. The seat track includes a first coupling segment formed on an end thereof, and the support track includes a second coupling segment formed on an end thereof. The first segment and the second segment are rotatably connected by two hinge elements. The seat track and the support track are connected to form the at least one connection track on which a massaging mechanism of the massage chair is driven to move back and forth, hence the massaging mechanism of the massage chair is driven to move back and forth on the at least one connection track. Preferably, the two hinge element are configured to connect the support track and the seat track to make the massaging mechanism move back and forth on the at least one connection track. Also, the support track and the seat track rotate at different angle so that the user is massaged successively when sitting or lying on the massage chair.

The frame of the massage chair contains the seat frame, the support frame, and the segmented guide rail. The seat track is fixed on the seat frame, and the support track is mounted on the support frame. Thereby, when the frame rotates to different angles, the massaging mechanism still moves back and forth on the at least one connection track to massage the user successively when sitting or lying on the massage chair.

A massage chair contains: the frame and the massaging mechanism. The massaging mechanism is disposed on the at least one connection track so as to be driven to move back and forth on the at least one connection track. Accordingly, when the support frame rotates to different angles, the massaging mechanism moves back and forth on the at least one connection track, thus massaging the user in different postures successively.

### BRIEF DESCRIPTION OF THE DRAWINGS

FIG. 1 is a perspective view showing the assembly of a segmented guide rail of a massage chair according to a preferred embodiment of the present invention.

FIG. 2 is a perspective view showing the assembly of a part of the segmented guide rail of the massage chair according to the preferred embodiment of the present invention.

FIG. 3 is a perspective view showing the exploded components of a part of the segmented guide rail of the massage chair according to the preferred embodiment of the present invention.

FIG. 4 is another perspective view showing the exploded components of a part of the segmented guide rail of the massage chair according to the preferred embodiment of the present invention.

FIG. 5 is a side plan view showing the assembly of a part of the segmented guide rail of the massage chair according to the preferred embodiment of the present invention.

FIG. 6 is a perspective view showing the assembly of a part of the segmented guide rail of the massage chair according to the preferred embodiment of the present invention.

FIG. 7 is another side plan view showing the assembly of a part of the segmented guide rail of the massage chair according to the preferred embodiment of the present invention.

FIG. 8 is a perspective view showing the assembly of the frame of the massage chair according to the preferred embodiment of the present invention.

### DETAILED DESCRIPTION

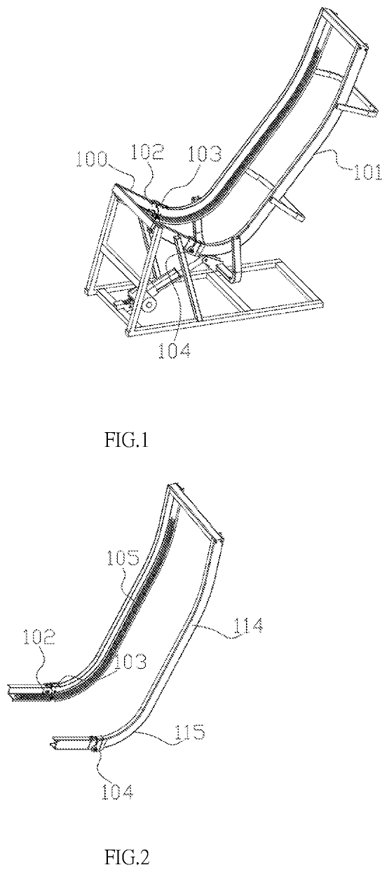

With reference to FIGS. 1 and 2, a segmented guide rail of a massage chair according to a preferred embodiment of the present invention comprises: a seat track 100 and a support track 101. The seat track 100 includes a first coupling segment 102 formed on an end thereof, and the support track 101 includes a second coupling segment 103 formed on an end thereof, wherein the first segment 102 and the second segment 103 are connected by two hinge elements 104. The seat track 100 and the support track 101 are connected to form at least one connection track 105 on which a massaging mechanism of the massage chair is driven to move back and forth.

The first segment 102 and the second segment 103 are connected by the two hinge elements 104 so that the seat track 100 and the support track 101 are connected to form the at least one connection track 105 which is rotatable, and the seat track 100 and the support track 101 guide a massaging mechanism of the massage chair to move back and forth at different angles. For example, an angle (i.e. a user sits on the massage chair) between the seat track 100 and the support track 101 is 90 degrees, and the massaging mechanism moves on the at least one connection track 105. When the angle between the seat track 100 and the support track 101 is 150 degrees (i.e. a user lies on the massage chair), the massaging mechanism moves on the at least one connection track 105.

The segmented guide rail of the massage chair comprises the seat track 100 and the support track 101, the seat track 100 includes the first segment 102 formed on an end thereof, the support track 101 includes the second segment 103 formed on an end thereof, wherein the first segment 102 and the second segment 103 are connected by the two hinge elements 104 to form the at least one connection track 105, such that the seat track 100 and the support track 101 are rotatably connected. Thereby, the massaging mechanism of the massage chair moves back and forth on the at least one connection 105 by way of the support track 101 and the seat track 100 of the guide rail. Preferably, the support track 101 and the seat track 100 rotate at different angles so that the user is massaged successively when sitting or lying on the massage chair.

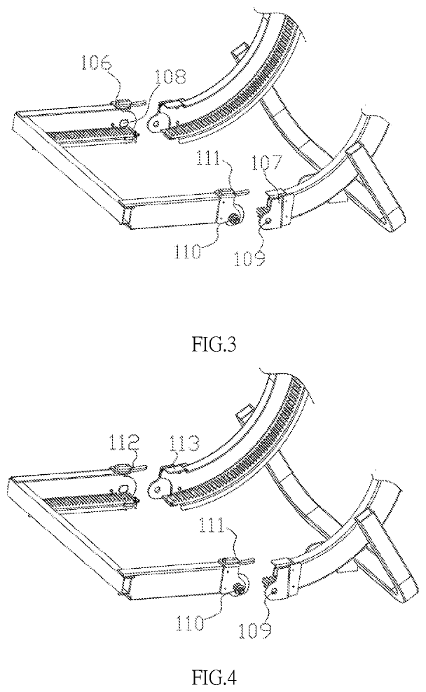

Referring to FIG. 3, a respective one hinge element 104 includes a first connection element 106 connected with the seat track 100 and located on the first segment 102, and the respective one hinge element 104 includes a second connection element 107 connected with the support track 101 and located on the second segment 103. The first connection element 106 has a first coupling orifice 108, and the second connection element 107 has a second coupling orifice 109, wherein a connection shaft 110 is inserted through the first coupling orifice 108 and the second coupling orifice 109.

Thereby, the seat track 100 and the support track 101 are rotatably connected by inserting the connection shaft 110 through the first coupling orifice 108 and the second coupling orifice 109, thus rotatably connecting a seat frame 119 with a support frame 120.

As shown in FIGS. 3 and 4, a defining element 111 is defined between the first segment 102 and the second segment 103, wherein the defining element 111 has a fixing stop part 112 fixed on the first segment 102, and the defining element 111 has a rotating limitation part 113 mounted on the second segment 103, wherein the rotating limitation part 113 contacts with the fixing stop part 112 to stop a rotation of the support track 101.

Thereby, the fixing stop part 112 is fixed on the first segment 102, the rotating limitation part 113 is mounted on the second segment 103, and the rotating limitation part 113 contacts with the fixing stop part 112 to stop the rotation of the support track 101. It is to be noted than a minimum angle and a maximum angle are defined between the support track 101 and the seat track 100. The fixing stop part 112 is configured to stop the rotating limitation part 113 so that the minimum angle between the seat track 100 and the support track 10 is 96 degrees and the maximum angle between the seat track 100 and the support track 101 is 160 degrees. In addition, the defining element 111 is configured to limit the minimum angle between the seat track 100 and the support track 101 but not limit the maximum angle between the seat track 100 and the support track 101. Also, the defining element 111 is configured to limit the minimum angle and the maximum angle between the seat track 100 and the support track 101.

As shown in FIG. 2, the support track 101 includes a linear slideway 114 and an arcuate slideway 115, an end of the arcuate slideway 115 is connected with the linear slideway 114, and the other end of the arcuate slideway 115 is connected with the second segment 103. It is to be noted that the massaging mechanism operates on the at least one connection track 105 smoothly by using the arcuate track 115 to make the at least one connection track 105 comply with a curve of human body and facilitate a massage of the massaging mechanism to the user. Preferably, a central angle of the arcuate track 115 is determined based on using requirements. For example, the central angle of the arcuate track 115 is 90 degrees.

With reference to FIGS. 5 and 7, the seat track 100 includes a first slideway 125 and a first rack 116 received in the first slideway 125. The support track 101 includes a second slideway 126 and a second rack 116 received in the second slideway 126. When the first rack 116 and the second rack 117 are connected to form the at least one connection track 105, a graduation line of the first rack 116 is connected with a graduation line of the second rack 117, and a rotatably axial center of the respective one hinge element 104 is located on a connection of the graduation lines of the first rack 116 and the second rack 117, such that the massaging mechanism moves smoothly when passing through the respective one hinge element 104.

The at least one connection track 105 includes the first slideway 125 and the second slideway 125 which are connected, and the at least one connection track 105 includes the first rack 116 and the second rack 117 so that the massaging mechanism moves on the first and second slideways and the first and second racks, thus enhancing a stability of the massaging mechanism passing through the respective one hinge element.

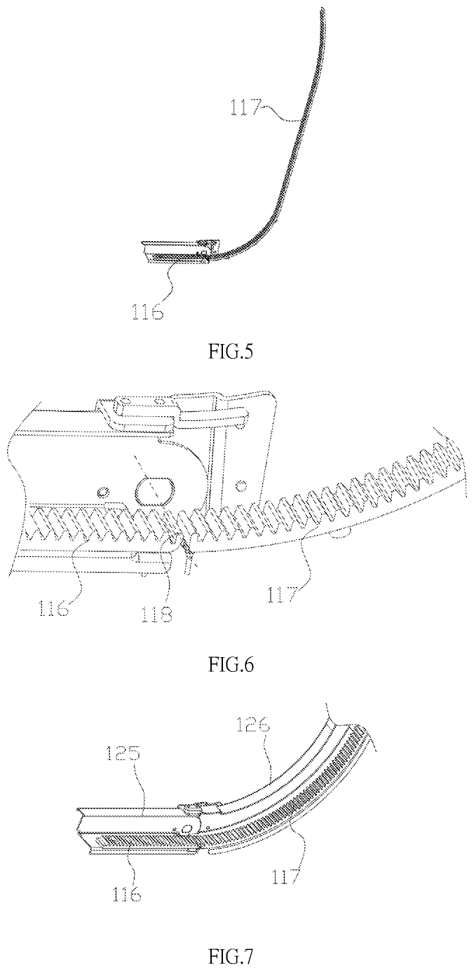

With reference to FIG. 6, the first segment 102 and the second segment 103 have an arcuate face 118 formed on toothed tops thereof, and a center of the arcuate face 118 of the first segment 102 and the second segment 103 is located on the graduation line of the first rack 116 and the graduation line of the second rack 117, such that the first rack 116 and the second rack 117 have the arcuate face 118 formed on the toothed tops of the first rack 116 and the second rack 117 so that the massaging mechanism moves smoothly on the first rack 116 and the second rack 117, thus moving the massaging mechanism on the seat track 100 and the support track 101 stably.

Referring to FIGS. 6 and 7, the first rack 116 is arranged on a bottom of the first slideway 125, and the second rack 117 is arranged on a bottom of the second slideway 126, such that the rotatably axial center of the respective one hinge element 104 is located on a bottom of a connection of the first slideway 125 and the second slideway 126. The fixing stop part 112 is located on a top of the first slideway 125 and corresponds to the rotatably axial center, and the rotating limitation part 113 is located on a top of the second slideway 126 and corresponds to the rotatably axial center. When the fixing stop part 112 stops the rotating limitation part 113, the fixing stop part 112 connects with the tops of the first slideway 125 and the second slideway 126 so that the at least one connection track 105 moves back and forth successively on the first slideway 125 and the second slideway 126.

The connection of the seat track 100 and the support track 101 has at least two connection tracks 105, for example, two connection tracks 105 are arranged on two sides of the massage chair. It is to be noted that a number and positions of the at least two connection tracks 152 are determined based on the using requirements.

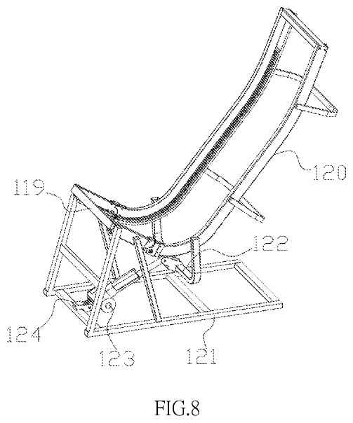

As shown in FIG. 8, a frame of the massage chair comprises the seat frame 119, the support frame 120, and the segmented guide rail, wherein the seat track 100 is fixed on the seat frame 119, and the support track 101 is mounted on the support frame 120.

Thereby, the frame is capable of making the massaging mechanism of the massage chair move back and forth, when the support frame 120 rotates to different angles, thus massaging the user in different postures successively.

As illustrated in FIG. 8, the seat frame 119 has a support structure 121 arranged on a bottom thereof, the support frame 120 has a joining stem 122 disposed on a bottom thereof, and the support structure 121 has a stretching element 123 mounted thereon, wherein the stretching element 123 is connected with the joining stem 122 by way of a tab 124, and the stretching element 123 pushes the support frame 120 to lift or descend by using the joining stem 122. The seat frame 119 has the support structure 121 arranged on the bottom thereof, and the stretching element 123 and the joining stem 122 drive the support 120 to rotatably lift and descend, hence the angle between the support track 101 and the seat track 100 is adjustably changed to massaging the user in the different angles. The massage chair comprises the frame and the massaging mechanism disposed on the segmented guide rail, wherein the massaging mechanism moves back and forth on the at least one connection track 105. The massage chair of the present invention comprises the frame and the massaging mechanism, wherein the massaging mechanism is disposed on the at least one connection track 105 and is driven to move back and forth on the at least one connection track 105. Accordingly, the massage chair is capable of making the massaging mechanism to move back and forth on the at least one connection track 105, when the support frame 120 rotates to the different angles, thus massaging the user in different postures successively.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A segmented guide rail of a massage chair comprising: a seat track and a support track;
wherein the seat track includes a first coupling segment formed on an end thereof, and the support track includes a second coupling segment formed on an end thereof; wherein the first segment and the second segment are connected by two hinge elements; the seat track and the support track are connected to form at least one connection track on which a massaging mechanism of the massage chair is driven to move back and forth.

2. The segmented guide rail of the massage chair as claimed in claim 1, wherein a respective one hinge element includes a first connection element connected with the seat track and located on the first segment, and the respective one hinge element includes a second connection element connected with the support track and located on the second segment; the first connection element has a first coupling orifice, and the second connection element has a second coupling orifice, wherein a connection shaft is inserted through the first coupling orifice and the second coupling orifice.

3. The segmented guide rail of the massage chair as claimed in claim 2, wherein a defining element is defined between the first segment and the second segment; wherein the defining element has a fixing stop part fixed on the first segment, and the defining element has a rotating limitation part mounted on the second segment, wherein the rotating limitation part contacts with the fixing stop part to stop a rotation of the support track.

4. The segmented guide rail of the massage chair as claimed in claim 2, wherein the support track includes a linear slideway and an arcuate slideway, an end of the arcuate slideway is connected with the linear slideway, and the other end of the arcuate slideway is connected with the second segment.

5. The segmented guide rail of the massage chair as claimed in claim 2, wherein the seat track includes a first slideway and a first rack received in the first slideway; the support track includes a second slideway and a second rack received in the second slideway; when the first rack and the second rack are connected to form the at least one connection track, a graduation line of the first rack is connected with a graduation line of the second rack, and a rotatably axial center of the respective one hinge element is located on a connection of the graduation lines of the first rack and the second rack.

6. The segmented guide rail of the massage chair as claimed in claim 5, wherein the first segment and the second segment have an arcuate face formed on toothed tops thereof, and a center of the arcuate face of the first segment and the second segment is located on the graduation line of the first rack and the graduation line of the second rack.

7. The segmented guide rail of the massage chair as claimed in claim 1, wherein a connection of the seat track and the support track has at least two connection tracks.

8. A frame of the massage chair comprising a seat frame, a support frame, and the segmented guide rail of the claim 1, wherein the seat track is fixed on the seat frame, and the support track is mounted on the support frame.

9. The frame of the massage chair as claimed in claim 8, wherein the seat frame has a support structure arranged on a bottom thereof, the support frame has a joining stem disposed on a bottom thereof, and the support structure has a stretching element mounted thereon, wherein the stretching element is connected with the joining stem by way of a tab, and the stretching element pushes the support frame to lift or descend by using the joining stem.

10. A massage chair comprising: the frame and the massaging mechanism of claim 8, wherein the massaging mechanism is disposed on the segmented guide rail, and the massaging mechanism moves back and forth on the at least one connection track.
